(19) United States
(12) Patent Application Publication
(10) Pub. No.: US 2009/0259381 A1
(43) Pub. Date: Oct. 15, 2009

(54) System for Monitoring Engine Performance of an Engine Via Torque Converter Operating Information

(76) Inventors: Thomas H. Wilson, Indianapolis, IN (US); Jeffrey K. Runde, Fishers, IN (US)

Correspondence Address: ALLISON TRANSMISSION, INC., BARNES & THORNBURG LLP, 11 SOUTH MERIDIAN STREET, INDIANAPOLIS, IN, 46204, US

(21) Appl. No.: 12/421,371

(22) Filed: Apr. 9, 2009

Related U.S. Application Data
(60) Provisional application No. 61/044,741, filed on Apr. 14, 2008.
(60) Provisional application No. 61/045,124, filed on Apr. 15, 2008.
(60) Provisional application No. 61/105,920, filed on Oct. 16, 2008.

(51) Int. Cl. G06F 19/00; G01P 3/00; G01K 1/00

(52) U.S. Cl. 701/101; 702/145; 702/130

(57) ABSTRACT

Determining performance of an internal combustion engine coupled to a pump of a torque converter may include determining a rotational speed of the pump, determining a rotational speed of a turbine fluidly coupled to the pump, determining an engine output torque value, corresponding to torque applied by the engine to the pump of the torque converter, as a function of the rotational speed of the pump and the rotational speed of the turbine, and storing the engine output torque value in a memory unit. Alternatively or additionally, engine horsepower may be determined as a function of the engine torque and/or a fuel efficiency of the engine may be determined as a function of the horsepower and fueling rate of the engine. The engine output torque value, horsepower value and/or fuel efficiency may be stored in a memory unit and/or displayed on a display unit.

### CROSS REFERENCE TO RELATED APPLICATION

This patent application claims priority to, and the benefit of, U.S. Provisional Patent Application No. 61/044,741 filed Apr. 14, 2008, Provisional Patent Application No. 61/045,124 filed Apr. 15, 2008, and Provisional Patent Application No. 61/105,920 filed Oct. 16, 2008, the disclosures of which are each incorporated herein by reference.

### FIELD OF THE INVENTION

The present invention relates generally to engine performance monitoring systems, and more specifically to systems for monitoring engine performance via torque converter operating information.

### BACKGROUND

Engine performance monitoring systems that monitor performance of an internal combustion engine based on engine operating information are known. It is desirable to monitor engine performance based on operating information relating to operation of a torque converter of a transmission.

### SUMMARY

The present invention may comprise one or more of the features recited in the attached claims, and/or one or more of the following features and combinations thereof. A method for determining performance of an internal combustion engine coupled to a pump of a torque converter, the torque converter having a turbine fluidly coupled to the pump, may comprise locking the turbine in a stationary position, determining a temperature of a fluid that fluidly couples the pump to the turbine, determining a rotational speed of the pump in response to a driver requested fueling value with the turbine locked in the stationary position, mapping the temperature of the fluid and the rotational speed of the pump to an engine output torque value, the engine output torque value corresponding to torque applied by the engine to the pump of the torque converter, and storing the engine output torque value in a memory unit.

The memory unit may have stored therein a plurality of stall torque maps that each map pump rotational speed values to engine output torque values for a different fluid temperature. In one embodiment, mapping the temperature of the fluid and the rotational speed of the pump to an engine output torque value may comprise retrieving from the memory unit a first one of the stall torque maps having a corresponding fluid temperature that is less than the temperature of the fluid, retrieving from the memory unit a second one of the stall torque maps having a corresponding fluid temperature that is greater than the temperature of the fluid, and interpolating between the first and the second ones of the stall torque maps to determine the engine output torque value based on the rotational speed of the pump. In an alternative embodiment, mapping the temperature of the fluid and the rotational speed of the pump to an engine output torque value may comprise retrieving from the memory unit a one of the stall torque maps having a corresponding fluid temperature that is closest in value to the temperature of the fluid, and determining from the one of the stall turbine torque maps the engine output torque value based on the rotational speed of the pump.

Locking the turbine in a stationary position comprises engaging a gear of the transmission. Alternatively or additionally, locking the turbine in a stationary position may comprise engaging service brakes of a vehicle carrying the engine and the torque converter. Alternatively or additionally, locking the turbine in a stationary position may comprise engaging one or more friction devices within the transmission.

The method may further comprise instructing an operator of a vehicle carrying the engine and the torque converter via a display unit to depress an accelerator pedal of the vehicle in a manner that achieves the driver requested fuel value.

The method may further comprise displaying the engine output torque value on a display unit.

The method may further comprise receiving another engine torque value from a control circuit configured to control operation of the engine, determining a difference between the engine torque value the another engine torque value, and storing and/or displaying the difference between the engine torque value and the another engine torque value.

The method may further comprise computing an engine horsepower value as a function of the engine output torque value and the rotational speed of the pump. The method may further comprise storing the engine horsepower value in the memory unit. Alternatively or additionally, the method may further comprise displaying the engine horsepower value on a display unit. The method may further comprise receiving another engine torque value from a control circuit configured to control operation of the engine, computing another engine horsepower value as a function of the another engine output torque value and the rotational speed of the pump, determining a difference between the engine horsepower value the another engine horsepower value, and storing and/or displaying the difference between the engine horsepower value and the another engine horsepower value.

The method may further comprise determining a fuel rate value corresponding to a fueling rate of the engine when supplying fuel to the engine according to the driver requested fueling value. The method may further comprise computing a fuel efficiency value as a function of the engine horsepower value and the fueling rate value. The method may further comprise storing the fuel efficiency value in the memory unit. Alternatively or additionally, the method may further comprise displaying the fuel efficiency value on a display unit. The method may further comprise receiving another engine torque value from a control circuit configured to control operation of the engine, computing another engine horsepower value as a function of the another engine output torque value and the rotational speed of the pump, computing another fuel efficiency value as a function of the another engine horsepower value and the fueling rate value, determining a difference between the fuel efficiency value and the another fuel efficiency value, and storing and/or displaying the difference between the fuel efficiency value and the another fuel efficiency value.

The method may further comprise computing a fuel consumption rate as a function of the fueling rate value. The method may further comprise storing the fuel consumption rate in the memory unit. Alternatively, the method may further comprise displaying the fuel consumption rate on a display unit.

A method for determining performance of an internal combustion engine coupled to a pump of a torque converter, the torque converter having a turbine fluidly coupled to the pump, may comprise locking the turbine in a stationary position, determining a temperature of a fluid that fluidly couples the pump to the turbine, determining a rotational speed of the pump in response to a driver requested fueling value with the turbine locked in the stationary position, mapping the temperature of the fluid and the rotational speed of the pump to an engine output torque value, computing an engine horsepower value as a function of the engine output torque value, and storing the engine horsepower value in a memory unit. The engine output torque value may correspond to torque applied by the engine to the pump of the torque converter,

The method may further comprise displaying the engine horsepower value on a display unit.

The memory unit may have stored therein a plurality of stall torque maps that each map pump rotational speed values to engine output torque values for a different fluid temperature. In,one embodiment, mapping the temperature of the fluid and the rotational speed of the pump to an engine output torque value may comprise retrieving from the memory unit a first one of the stall torque maps having a corresponding fluid temperature that is less than the temperature of the fluid, retrieving from the memory unit a second one of the stall torque maps having a corresponding fluid temperature that is greater than the temperature of the fluid, and interpolating between the first and the second ones of the stall torque maps to determine the engine output torque value based on the rotational speed of the pump. In an alternative embodiment, mapping the temperature of the fluid and the rotational speed of the pump to an engine output torque value may comprise retrieving from the memory unit a one of the stall torque maps having a corresponding fluid temperature that is closest in value to the temperature of the fluid, and determining from the one of the stall turbine torque maps the engine output torque value based on the rotational speed of the pump.

Locking the turbine in a stationary position may comprise engaging a numerically low gear of the transmission. Alternatively or additionally, locking the turbine in a stationary position may comprise engaging service brakes of a vehicle carrying the engine and the torque converter.

The method may further comprise instructing an operator of a vehicle carrying the engine and the torque converter via a display unit to depress an accelerator pedal of the vehicle in a manner that achieves the driver requested fuel value.

A method for determining performance of an internal combustion engine coupled to a pump of a torque converter, wherein the torque converter has a turbine fluidly coupled to the pump, may comprise determining a rotational speed of the pump, determining a rotational speed of the turbine, determining an engine output torque value, corresponding to torque applied by the engine to the pump of the torque converter, as a function of the rotational speed of the pump and the rotational speed of the turbine, and storing the engine output torque value in a memory unit.

The torque converter may have a lockup clutch connected between the pump and the turbine. The torque converter may be operable in a lockup mode when the lockup clutch is engaged to secure the pump to the turbine and in a torque converter mode when the lockup clutch is disengaged. In one embodiment, the method is executed only when the lockup clutch is disengaged.

The method may further comprise displaying the engine output torque value on a display unit.

The method may further comprise computing an engine horsepower value as a function of the engine output torque value. The method may further comprise storing the engine horsepower value in the memory unit. Alternatively or additionally, the method may further comprise displaying the engine horsepower value on a display unit.

The method may further comprise determining a fuel rate value corresponding to a fueling rate of the engine when supplying fuel to the engine. In one embodiment, the method may further comprise computing an engine horsepower value as a function of the engine output torque value, and computing a fuel efficiency value as a function of the engine horsepower value and the fueling rate value. In this embodiment, the method may further comprise storing the fuel efficiency value in the memory unit. Alternatively or additionally, the method may further comprise displaying the fuel efficiency value on a display unit. In another embodiment, the method may alternatively or additionally comprise computing a fuel consumption rate as a function of the fueling rate value. In this embodiment the method may further comprise storing the fuel consumption rate in the memory unit. Alternatively or additionally, the method may further comprise displaying the fuel consumption rate on a display unit.

A method for determining performance of an internal combustion engine coupled to a pump of a torque converter, wherein the torque converter has a turbine fluidly coupled to the pump, may comprise determining a rotational speed of the pump, determining a rotational speed of the turbine, determining an engine output torque value, corresponding to torque applied by the engine to the pump of the torque converter, as a function of the rotational speed of the pump and the rotational speed of the turbine, computing an engine horsepower value as a function of the engine output torque value, and storing the engine horsepower value in a memory unit.

The torque converter may have a lockup clutch connected between the pump and the turbine. The torque converter may be operable in a lockup mode when the lockup clutch is engaged to secure the pump to the turbine and in a torque converter mode when the lockup clutch is disengaged. In one embodiment, the method may be executed only when the lockup clutch is disengaged.

The method may further comprise displaying the engine horsepower value on a display unit.

The method may further comprise determining a fuel rate value corresponding to a fueling rate of the engine when supplying fuel to the engine. In one embodiment, the method may further comprise computing a fuel efficiency value as a function of the engine horsepower value and the fueling rate value. The method may further comprise storing the fuel efficiency value in the memory unit. Alternatively or additionally, the method may further comprise displaying the fuel efficiency value on a display unit. In another embodiment, the method may further comprise computing a fuel consumption rate as a function of the fueling rate value. In one embodiment, the method may further comprise storing the fuel consumption rate in the memory unit. Alternatively or additionally, the method may further comprise displaying the fuel consumption rate on a display unit.

### BRIEF DESCRIPTION OF THE DRAWINGS

FIG. 1 is a block diagram of one illustrative embodiment of a system for monitoring the performance of an internal combustion engine via torque converter operating information.

FIG. 2 is a flowchart of one illustrative embodiment of a process for monitoring the performance of an internal combustion engine via torque converter operating information.

FIG. 3 is a stall turbine map defining torque applied to the pump shaft of a torque converter as a function of rotational speed of the pump at a particular transmission oil temperature

FIG. 4 is a flowchart of one illustrative embodiment of a process for comparing the performance of an internal combustion engine based on information provided by an engine controller and on information relating to operation of the torque converter.

FIG. 5 is a flowchart of another illustrative embodiment of a process for monitoring the performance of an internal combustion engine via torque converter operating information.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

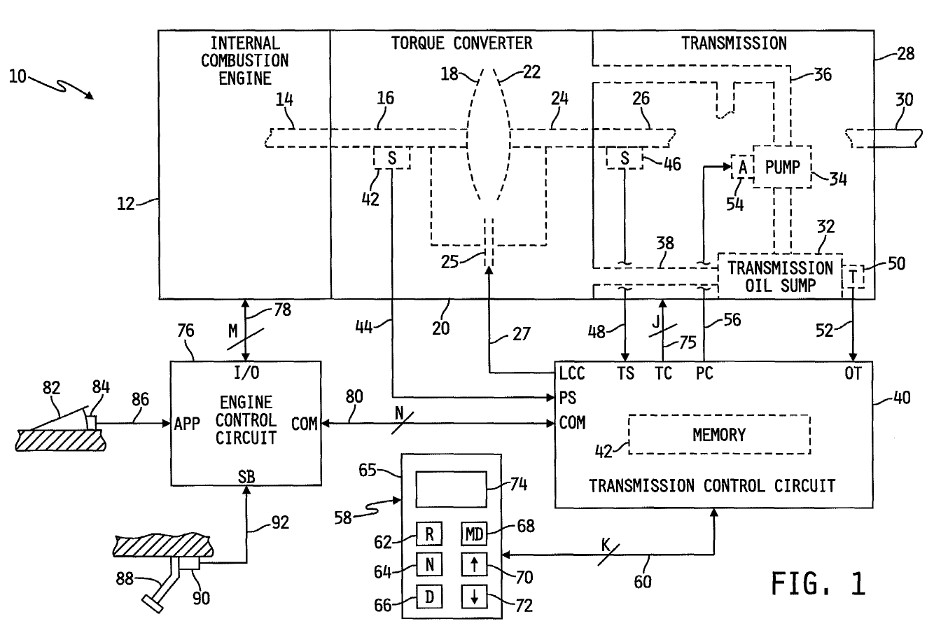

Referring now to FIG. 1, a block diagram is shown of one illustrative embodiment of a system 10 for monitoring the performance of an internal combustion engine via torque converter operating information. In the illustrated embodiment, the system 10 includes an internal combustion engine 12 that is configured to rotatably drive an output shaft 14 that is coupled to an input or pump shaft 16 of a conventional torque converter 20. The input or pump shaft 16 is attached to an impeller or pump 18 that is rotatably driven by the output shaft 14 of the engine 12. The torque converter 20 further includes a turbine 22 that is attached to a turbine shaft 24, and the turbine shaft 24 is coupled to, or integral with, a rotatable input shaft 26 of a transmission 28. The pump 18 is fluidly coupled to the turbine 22 via a conventional fluid, e.g., a conventional transmission oil, as will be discussed in greater detail hereinafter.

A conventional lockup clutch 25 is connected between the pump 18 and the turbine 22. The operation of the torque converter 20 is conventional in that the torque converter 20 is operable in a so-called “torque converter” mode during certain operating conditions such as vehicle launch, low speed and certain gear shifting conditions. In the torque converter mode, the lockup clutch 25 is disengaged and the pump 18 rotates at the rotational speed of the engine output shaft 14 while the turbine 22 is rotatably actuated by the pump 18 through a fluid (not shown) interposed between the pump 18 and the turbine 22. In this operational mode, torque multiplication occurs through the fluid coupling such that the turbine shaft 24 is exposed to more drive torque than is being supplied by the engine 12, as is known in the art. The torque converter 20 is alternatively operable in a so-called “lockup” mode during other operating conditions, such as when certain gear ratios of the transmission 28 are engaged. In the lockup mode, the lockup clutch 25 is engaged and the pump 18 is thereby secured to directly to the turbine 22 so that the engine output shaft 14 is directly coupled to the input shaft 26 of the transmission 28, as is also known in the art.

The transmission 28 is conventional and includes a number of automatically selected gear ratios. An output shaft 30 of the transmission is coupled to, and rotatably drives, a number of wheels (not shown) of a vehicle carrying the engine 12, torque converter 20 and transmission 28. As it relates to this disclosure, the transmission 12 includes a transmission oil reservoir or sump 32 that is configured to hold a quantity of conventional transmission oil. The transmission oil reservoir 32 is fluidly coupled via a conduit to an input of a conventional oil pump 34 having an output that is fluidly coupled via a conduit 36 to components within the transmission 28 and also to the torque converter 20 such that fluid from the sump 32 is provided by the pump 34 to the torque converter 20 to provide lubrication and to also provide the fluid coupling between the pump 18 and the turbine 22. Another conduit 38 is fluidly coupled between the torque converter 20 and the sump 32 to provide a return path for transmission oil in the torque converter back to the sump 32.

The system 10 further includes a transmission control circuit 40 that includes a memory unit 42. The transmission control circuit 40 is illustratively microprocessor-based, and the memory unit 42 generally includes instructions stored therein that are executable by the transmission control circuit 40 to control operation of the torque converter 20 and the transmission 28. It will be understood, however, that this disclosure contemplates other embodiments in which the transmission control circuit 40 is not microprocessor-based, but is configured to control operation of the torque converter 20 and/or transmission 28 based on one or more sets of hardwired instructions and/or software instructions stored in the memory unit 42.

In the system 10 illustrated in FIG. 1, the torque converter 20 and the transmission 28 each include one or more sensors configured to produce sensor signals that are indicative of one or more operating states of the torque converter 20 and/or the transmission 28. For example, the torque converter 20 includes the conventional speed sensor 42 that is positioned and configured to produce a speed signal corresponding to the rotational speed of the torque converter pump shaft 16 (which is also the rotational speed of the output shaft 14 of the engine 12). The speed sensor 42 is electrically connected to a pump speed input, PS, of the transmission control circuit 40 via a signal path 44, and the transmission control circuit 40 is operable to process the speed signal produced by the speed sensor 42 in a conventional manner to determine the rotational speed of the pump shaft 16.

The transmission 28 further includes a second speed sensor 46 that is positioned and configured to produce a speed signal corresponding to the rotational speed of the input shaft 26 of the transmission 28. The input shaft 26 of the transmission 28 is directly coupled to, or integral with, the turbine shaft 24, and the speed sensor 46 may alternatively be positioned and configured to produce a speed signal corresponding to the rotational speed of the turbine shaft 24. In any case, the speed sensor 46 may be conventional, and is electrically connected to a turbine speed input, TS, of the transmission control circuit 40 via a signal path 48. The transmission control circuit 40 is configured to process the speed signal produced by the speed signal 46 in a conventional manner to determine the rotational speed of the turbine shaft 24/input shaft 26 of the transmission 28.

The transmission 38 further includes a temperature sensor 50 that is positioned and configured to produce a temperature signal corresponding to the operating temperature of the transmission oil. The temperature sensor 50 is electrically connected to an oil temperature input, OT, of the transmission control circuit 40 via a signal path 52, and the transmission control circuit 40 is operable to process the temperature signal produced by the temperature sensor 50 in a conventional manner to determine the operating temperature of the transmission oil. In the illustrated embodiment, the temperature sensor 50 is shown in fluid communication with the sump 32, although it will be understood that the temperature sensor 50 may alternatively be positioned in fluid communication with other components through which or in which the transmission oil flows.

In the illustrated embodiment, the torque converter 20 and the transmission 28 each further include one or more actuators configured to control various operations within the torque converter 20 and/or transmission 28 respectively. For example, the torque converter 20 or transmission 28 includes a conventional actuator (not shown) that is electrically connected to a lockup clutch control output, LCC, of the transmission control circuit 40 via a signal path 27. The lockup clutch actuator may be conventional, and is configured to be responsive to the lockup clutch control signal, LCC, produced by the transmission control circuit 40 to control operation of the lockup clutch 25 as described hereinabove. The transmission 28 may further include pump actuator 54 that is electrically connected to a pump control output, PC, of the transmission control circuit 40 via a signal path 56. If included, the pump actuator 54 is responsive to the pump control signals, PC, produced by the transmission control circuit 40 to control operation of the transmission oil pump 34 in a conventional manner to regulate the pressure of transmission oil supplied by the pump 34. The transmission 28 further includes a number of additional actuators, e.g., one or more conventional solenoids that are generally illustrated as being electrically connected to a transmission control port, TC, of the transmission control circuit 40 via a number, J, of signal paths 75, wherein J may be any positive integer.

The system 10 further includes a conventional shift selector module 58 having a housing 65 to which a number of electrical components are mounted. For example, a number of user-selectable switches 62, 64, 66, 68, 70 and 72 are coupled to the housing 65, wherein the switches 62, 64 and 66 corresponding reverse (R), neutral (N) and drive (D) states respectively of the transmission 28, the switches 70 and 72 correspond to manual bump up and bump down shifting respectively of the transmission 28 and the switch 68 is a conventional mode switch. The shift selector module 58 further includes a conventional display unit 74 mounted to the housing, wherein the display unit 74 may be or include a liquid crystal display device, a light emitting diode display device, a vacuum fluorescent display device or the like. In any case the switches 62-72 and the display device 74 are electrically connected to the transmission control circuit 40 via a number, K, of signal paths, wherein K may be any positive integer. The memory unit 42 has stored therein one or more sets of instructions that are executable by the transmission control circuit 40 to control operation of the transmission 28 in accordance with switch information provided by the shift selector module 58 and to provide visual feedback relating to operation of the transmission 28 to an operator of the vehicle via the display unit 74.

In the illustrated embodiment, the system 10 further includes an engine control circuit 76 having an input/output port (I/O) that is electrically coupled to the engine 12 via a number, M, of signal paths 78, wherein M may be any positive integer. The engine control circuit 76 may be conventional, and is operable to control and manage the overall operation of the engine 12. The engine control circuit 76 further includes a communication port, COM, that is electrically connected to a similar communication port, COM, of the transmission control circuit 40 via a number, N, of signal paths 80, wherein N may be any positive integer. The one or more signal paths 80 are typically referred to collectively as a data link. Generally, the engine control circuit 76 and the transmission control circuit 40 are operable to share information via the one or more signal paths 80 in a conventional manner. In one embodiment, for example, the engine control circuit 76 and transmission control circuit 40 are operable to share information via the one or more signal paths 80 in the form of one or more messages accordance with a society of automotive engineers (SAE) J-1939 communications protocol, although this disclosure contemplates other embodiments in which the engine control circuit 76 and the transmission control circuit 40 are operable to share information via the one or more signal paths 80 in accordance with one or more other conventional communication protocols.

The system 10 further includes a conventional accelerator pedal 82 that is typically positioned in a cab area of the vehicle carrying the engine 12, torque converter 20 and transmission 28. A conventional accelerator pedal position sensor 84 is electrically connected to an accelerator pedal position input, APP, of the control circuit 40 via a signal path 86. The sensor 84 is configured to produce a position signal corresponding to a position of the accelerator pedal 82 relative to a reference position, and the engine control circuit 76 is configured to process the position signal in a conventional manner to determine a corresponding accelerator pedal position or percentage relative to a reference position or percentage.

The system 10 further includes a conventional service brake pedal 88 that is typically positioned in a cab area of the vehicle carrying the engine 12, torque converter 20 and transmission 28. A conventional brake pedal position sensor or switch 90 is illustratively electrically connected to a service brake pedal position input, SB, of the engine control circuit 76 via a signal path 92. Alternatively or additionally, the sensor or switch 90 may be electrically connected to a service brake pedal position input of the transmission control circuit 40. In either case, the sensor or switch 90 is configured to produce a position signal corresponding to a position of the brake pedal 88 relative to a reference position, and the engine control circuit 76 and/or transmission control circuit 40 is configured to process the position signal in a conventional manner to determine a corresponding brake pedal position or percentage relative to a reference position or percentage.

As it relates to at least one embodiment of this disclosure, the transmission control circuit 40 is operable to receive certain operating information relating to operation of the engine 12 from the engine control circuit 76 via the one or more signal paths 80 in a conventional manner. For example, the engine control circuit 76 is configured in a conventional manner to determine a driver requested fueling value corresponding to the current position or percentage of the accelerator pedal 82 relative to a reference accelerator pedal position or percentage and/or to corresponding to a current setting of a conventional cruise control unit (not shown). In either case, the engine control circuit 76 is operable to determine the driver requested fueling value, for example in the form of a throttle percentage relative to 0% throttle, and in the illustrated embodiment the engine control circuit 76 is operable to supply the driver requested fueling information, e.g., the throttle percentage, to the transmission control circuit 40 via the one or more signal paths 80, such as in the form of a message that the transmission control circuit 40 may process to determine a corresponding driver requested fueling, e.g., throttle percentage, value. As another example, the engine control circuit 76 is configured in a conventional manner to determine a fueling rate, FR, in a conventional manner that corresponds to the current fueling rate of the engine 12. The engine control circuit 76 is operable to determine the current engine fueling rate, and in the illustrated embodiment the engine control circuit 76 is operable to supply the current fueling rate information to the transmission control circuit 40 via the one or more signal paths 80, such as in the form of a message that the transmission control circuit 40 may process to determine a corresponding fueling rate of the engine.

As yet another example, the engine control circuit 76 is configured in a conventional manner to determine an engine output torque, T_{E}, in a conventional manner that corresponds to the current output torque produced by the engine 12. The engine control circuit 76 is operable to determine the current engine output torque, and in the illustrated embodiment the engine control circuit 76 is operable to supply the current engine output torque information to the transmission control circuit 40 via the one or more signal paths 80, such as in the form of a message that the transmission control circuit 40 may process to determine a corresponding engine output torque value. As a further example, the engine control circuit 76 may be operable in a conventional manner to determine the current status of the vehicle service brakes, e.g., by monitoring the signal produced by the service brake sensor or switch 90 or by monitoring the status of the brake lights of the vehicle (not shown), and in the illustrated embodiment the engine control circuit 76 is operable to supply the service brake status information to the transmission control circuit 40 via the one or more signal paths 80, such as in the form of a message that the transmission control circuit 40 may process to determine the status of the vehicle service brakes. Alternatively or additionally, the signal path 92 may be connected directly to the transmission control circuit 40. As still a further example, the engine control circuit 76 may be operable in a conventional manner to determine the rotational speed of the engine output shaft 14, e.g., by monitoring a signal produced by a conventional engine speed sensor, and in the illustrated embodiment the engine control circuit 76 may be operable to supply the engine speed signal information to the transmission control circuit 40 via the one or more signal paths 80, such as in the form of a message that the transmission control circuit 40 may process to determine the rotational speed of the engine 12 as determined by the engine control circuit 76.

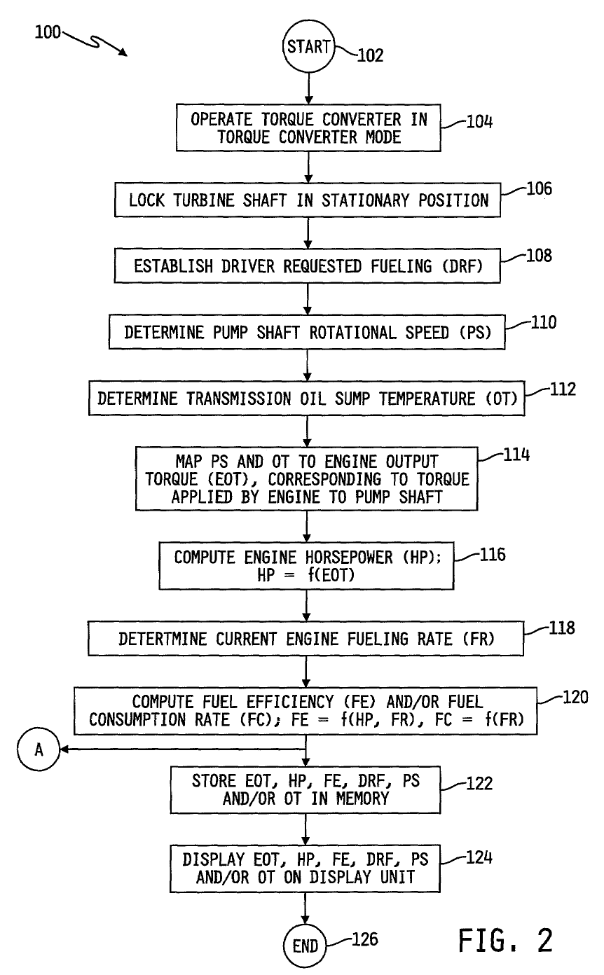

Referring now to FIG. 2, a flowchart is shown of one illustrative embodiment of a process 100 for monitoring the performance of an internal combustion engine via torque converter operating information. The process 100 is illustratively stored in the memory unit 42 in the form of instructions that are executable by the control circuit 40 to monitor the performance of the internal combustion engine 12. The process 100 begins at step 102, and thereafter at step 104 the transmission control circuit 40 is operable to control the torque converter clutch 25 in a conventional manner to operate the torque converter 20 in the torque converter mode, i.e., with the torque converter clutch 25 disengaged. Thereafter at step 106, the transmission control circuit 40 is operable to lock the turbine shaft 26 in a stationary position. Illustratively, the transmission control circuit 40 is operable to execute step 106 by engaging the transmission 28 in one of the selectable gears. The transmission control circuit 40 may be alternatively or additionally operable at step 106 to instruct an operator of a vehicle carrying an engine 12, torque converter 20 and transmission 28 to engage the service brakes 88. The transmission control circuit 40 may be alternatively or additionally operable at step 106 to engage one or more friction devices, e.g., clutches and/or brakes, within the transmission 28. The transmission control circuit 40 may be further operable at step 106 to verify that the turbine shaft 26 is locked in a stationary position by monitoring a currently engaged gear of the transmission, and/or by monitoring the signal produced by the brake pedal position sensor 90 (or by monitoring a status of brake lights carried by the vehicle), and/or by monitoring one or more currently engaged friction devices within the transmission 40 and/or by monitoring the output of the speed sensor 46.

Following step 106, the process 100 advances to step 108 where a driver requested fueling value, DRF, is established. Illustratively, the driver requested fueling value, DRF, corresponds to a position of the accelerator pedal 82 relative to a reference position. The driver requested fueling value, DRF, is thus illustratively established when an operator of the vehicle depresses the accelerator pedal 82 to produce a driver requested fueling value, DRF, that is greater than the reference value, e.g., zero. The engine control circuit 76 is illustratively operable to supply the driver requested fueling value, e.g., in the form of the throttle percentage or position value, to the transmission control circuit 40 via the one or more signal paths 80. Illustratively, the transmission control circuit 40 may be operable at step 108 to instruct an operator, e.g., via the display unit 74 of the transmission gear selector unit 58, to establish a specific driver requested fueling value, e.g., throttle percentage by instructing an operator via the display unit 74 to depress the accelerator pedal 82 in a manner that achieves the driver requested fuel value, DRF.

In any case, the process 100 advances from step 108 to step 110 where the transmission control circuit 40 is operable to determine the pump shaft rotational speed, PS. Illustratively, the transmission control circuit 40 is operable at step 110 to determine the pump shaft rotational speed, PS, by processing the signal produced by the speed sensor 42 to determine the rotational speed of the pump shaft 16. Alternatively, the transmission control circuit 40 may be operable at step 110 to determine the pump shaft rotational speed, PS, by receiving or retrieving the engine rotational speed value from the engine control circuit 76 via the one or more signal paths 80. The transmission control circuit 40 may be further operable at step 110 to display the rotational speed of the pump shaft 16, which corresponds to the rotational speed of the output shaft 14 of the engine 12, on the display unit 74 or other conventional display unit controlled by the transmission control circuit 40 to provide the vehicle operator with visual feedback of the current engine rotational speed. Following step 110, the process 100 advances to step 112 where the transmission control circuit 40 is operable to determine the transmission oil sump temperature, OT. Illustratively, the transmission control circuit 40 is operable to determine the transmission oil sump temperature, OT, by processing the temperature signal produced by the temperature sensor 50 to determine therefrom the transmission oil temperature.

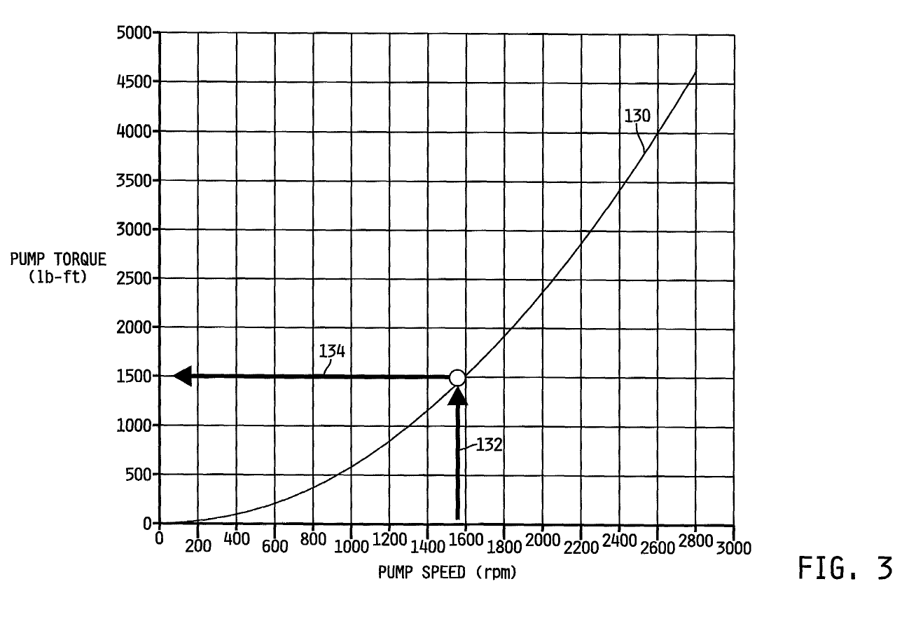

Following step 112, the process 100 advances to step 114 where the transmission control circuit 40 is operable to map the pump shaft rotational speed value, PS, and the transmission oil sump temperature, OT, to an engine output torque value, EOT, which corresponds to the torque applied by the engine to the pump shaft 16. Illustratively, the memory unit 42 of the transmission control circuit 40 has stored therein a number of so-called stall-torque maps that each map, at a different transmission oil sump temperature, current values of the pump shaft rotational speed, PS to pump shaft torque values, which correspond to engine output torque values. Referring to FIG. 3, for example, one illustrative example of a stall-torque map for one particular transmission oil sump temperature is shown. In the illustrated embodiment, the stall torque map defines a curve 130 that maps, at the particular transmission oil sump temperature, values of pump shaft rotational speed (RPM) to values of pump shaft torque, i.e., engine output torque (lb-ft). The memory unit 42 illustratively has a plurality of such stall torque maps stored therein that each map values of pump shaft rotational speed to values of pump shaft torque at a different transmission oil sump temperature.

In one embodiment, the transmission control circuit 40 is operable at step 114 to map PS and OT to engine output torque values (EOT), corresponding to torque applied by the engine 12 to the pump shaft 16, by retrieving from the memory unit 42 a stall torque map having a corresponding transmission oil sump temperature that is less than the current transmission oil sump temperature, OT, retrieving from the memory unit 42 a stall torque map having a corresponding transmission oil sump temperature that is greater than the current oil sump temperature, OT, and interpolating between the two retrieved stall torque maps, using conventional interpolation techniques, to determine the engine output torque value (EOT) based on the rotational speed of the pump (PS). In one alternative embodiment, the transmission control circuit 40 is operable at step 114 to map PS and OT to engine output torque values (EOT), corresponding to torque applied by the engine 12 to the pump shaft 16, by retrieving from the memory unit 42 a stall torque map having a corresponding transmission oil temperature that is closest in value to the current transmission oil temperature, OT, and determining from the retrieved stall turbine torque map the engine output torque value (EOT) based on the rotational speed of the pump (PS). Those skilled in the art will recognize other conventional techniques for determining from one or more of the plurality of stall turbine torque maps stored in the memory 42 the engine output torque value (EOT) based on the rotational speed of the pump (PS), and any such other conventional techniques are contemplated by this disclosure. Those skilled in the art will recognize that one or more maps that map pump shaft rotational speed values, PS, and transmission oil sump temperatures, OT, to engine output torque values, EOT, may alternatively be stored in the memory unit 42 in the form of one or more charts, graphs, equations or the like.

The process 100 advances from step 114 to step 116 where the transmission control circuit 40 is operable to compute engine horse power, HP, as a function of the engine output torque value, EOT, determined at step 114. Illustratively, the transmission control circuit 40 is operable to compute HP at step 116 using a known relationship between HP, PS and EOT. As one specific example, the transmission control circuit 40 is operable at step 116 to compute the engine horse power, HP, according to the equation HP=(EOT*PS)/5252.

Following step 116, the process 100 advances to step 118 where the transmission control circuit 40 is operable to determine the current engine fueling rate, FR. Illustratively, the engine control circuit 76 is operable to supply fueling rate values to the transmission control circuit 40 via the one or more signal paths 80. The transmission control circuit 40 is thus operable at step 118 to determine the current engine fueling rate, FR, by receiving or retrieving FR from the engine control circuit 76. Thereafter at step 120, the transmission control circuit 40 is operable to compute a fuel efficiency value, FE, as a function of the engine horse power, HP, and the current engine fueling rate, FR. The transmission control circuit 40 may be operable at step 120 to compute the fuel efficiency value, FE, according to any known relationship between FR and HP, and in one embodiment, the transmission control circuit 40 may be operable to compute FE at step 120 according to the equation FE=FR/HP. Alternatively or additionally, the transmission control circuit 40 may be operable at step 120 to compute a fuel consumption rate value, FC, as a conventional function of the current engine fueling rate, FR, over time or per unit of time.

Following step 120, the process 100 advances to step 122 where the transmission control circuit 40 is operable to store in the memory unit 42 any one more of the computed and/or monitored values EOT, HP, FE, FC, DRF, PS and/or OT. Either or both of the target, i.e., displayed, driver requested fuel, DRF, and the actual value of DRF may be stored in the memory unit 42. Alternatively or additionally, step 120 may advance to a process “A” as illustrated in FIG. 2. In any case, the process 100 advances from step 122 to step 124 where the transmission control circuit 40 is operable to display on the display unit 74 or other display unit any one or more of the computed and/or monitored values EOT, HP, FE, FC, DRF, PS and/or OT. Thereafter at step 126, the process 100 ends.

It will be understood that the process 100 just illustrated and described may be modified such that the transmission control circuit 40 is operable to compute and display and/or store only one or any combination of EOT, HP and FE. Those skilled in the art will recognize that the process 100 may be modified to compute, display and/or store any one or combination of EOT, HP and FE simply by omitting certain steps illustrated in the flow chart depicted in FIG. 2. Any such modifications would be a mechanical step for a person of ordinary skill in the art.

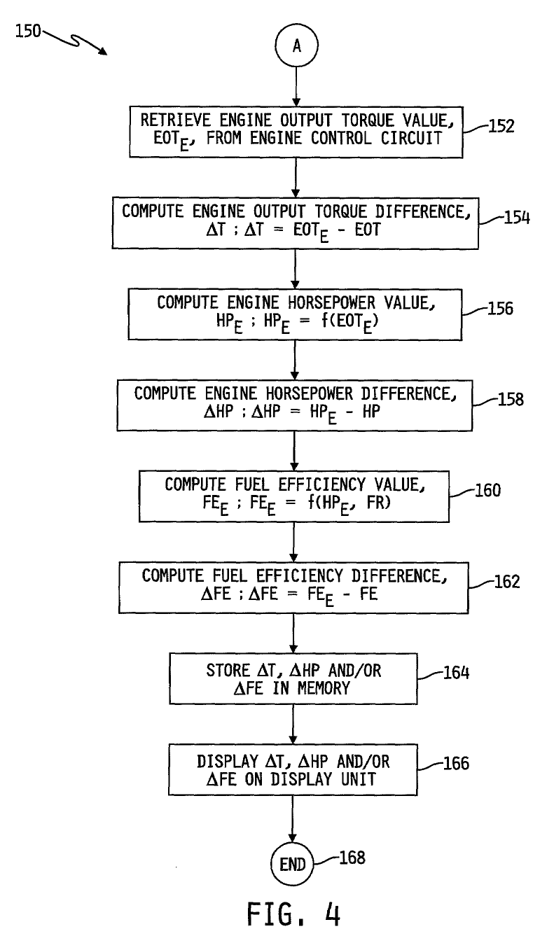

Referring now to FIG. 4, a flowchart is shown of one illustrative embodiment of the process “A” identified in the flowchart of FIG. 2. The process “A” is illustratively provided in the form of a process 150 for comparing the performance of the engine 12 based on engine output torque information provided by the engine control circuit 76 and on information relating to the operation of the torque converter 20. The process 150 begins at step 152, which follows from step 120 of the process 100 of FIG. 2. It will be appreciated, however, that step 152 may alternatively follow from either of steps 114 or 116, depending upon the number of parameters being compared. In the embodiment illustrated in FIG. 4, the transmission control circuit 40 is operable at step 152 to receive or retrieve an engine output torque value, EOT_{E}, from the engine control circuit 76 via the one or more signal paths 80 as described hereinabove. The engine output torque value, EOT_{E}, as described above, is the engine output torque value that is determined by the engine control circuit 76 in accordance with one or more conventional algorithms executed thereby. Following step 152, the process 150 advances to step 154 where the transmission control circuit 40 is operable to determine an engine output torque difference, ΔT, as a difference between the engine output torque value, EOT_{E}, and the engine output torque, EOT, that was determined at step 114 of the process 100 of FIG. 2.

Following step 154, the transmission control circuit 40 is operable at step 156 to compute another engine horsepower value, HP_{E}, as a conventional function of the engine output torque value, EOT_{E}, provided by the engine control circuit 76 via the one or more signal paths 80. Illustratively, the transmission control circuit 40 is operable to compute HP_{E} as a function of EOT_{E} and PS according to the equation HP_{E}=(EOT_{E}*PS)/5252, although the transmission control circuit 40 may alternatively compute HP_{E} at step 156 using one or more other known functions of EOT_{E.} In any case, the process 150 advances from step 156 to step 158 where the transmission control circuit 40 is operable to determine an engine horsepower difference, ΔHP, as a difference between the engine horsepower value, HP_{E}, and the engine horsepower value, HP, that was determined at step 116 of the process 100 of FIG. 2.

Following step 158, the transmission control circuit 40 is operable at step 160 to compute another fuel efficiency value, FE_{E}, as a conventional function of the engine horsepower value, HP_{E}, computed at step 156 and of the fueling rate, FR, determined at step 118 of the process 100 of FIG. 2. The process 150 advances from step 160 to step 162 where the transmission control circuit 40 is operable to determine an fuel efficiency difference, ΔFE, as a difference between the fuel efficiency value, FE_{E}, and the fuel efficiency value, FE, that was determined at step 120 of the process 100 of FIG. 2. Following step 162, the transmission control circuit 40 is operable at step 164 to store any one or more of ΔT, ΔHP and ΔFE in the memory unit 42. Thereafter at step 166, the transmission control circuit 40 may be operable to display on the display unit 74 or other display unit any one or more of ΔT, ΔHP and ΔFE. Thereafter at step 168, the process 150 ends.

It will be understood that the process 150 just illustrated and described may be modified such that the transmission control circuit 40 is operable to compute and display and/or store only one or any combination of ΔT, ΔHP and ΔFE. Those skilled in the art will recognize that the process 150 may be modified to compute, display and/or store any one or combination ΔT, ΔHP and ΔFE simply by omitting certain steps illustrated in the flow chart depicted in FIG. 4 and/or by advancing to the process 150 from other appropriate steps of the process 100 of FIG. 2. Any such modifications would be a mechanical step for a person of ordinary skill in the art.

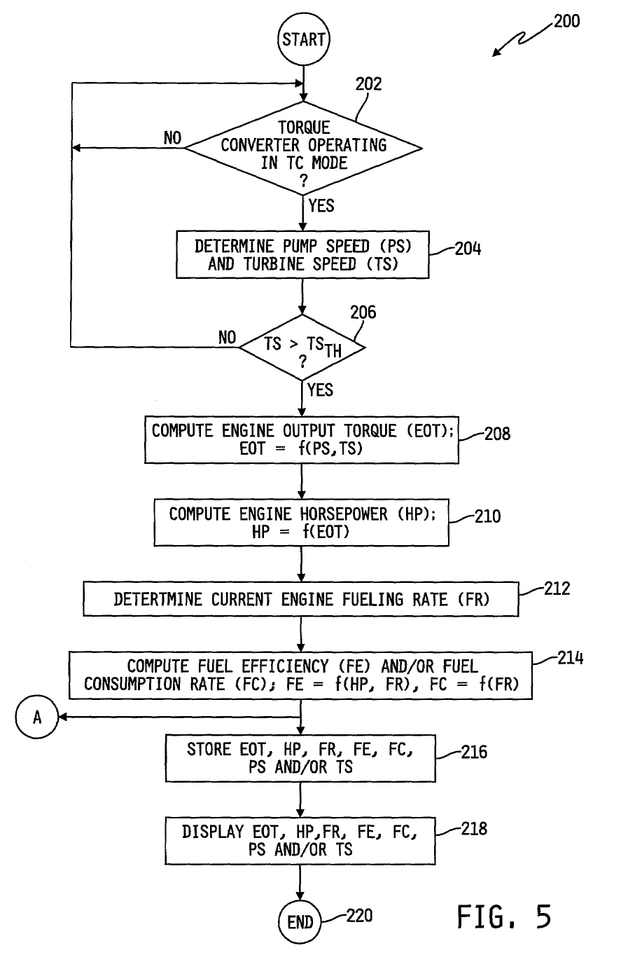

Referring now to FIG. 5, a flowchart is shown of another illustrative embodiment of a process 200 for monitoring the performance of an internal combustion engine via torque converter operating information. The process 200 is illustratively stored in the memory unit 42 in the form of instructions that are executable by the control circuit 40 to monitor the performance of the internal combustion engine 12. The process 200 begins at step 202 where the transmission control circuit 40 is operable to determine whether the torque converter 20 is operating in the torque converter operating mode as described hereinabove. Illustratively, the transmission control circuit 40 is operable at step 202 to determine whether the torque converter 40 is operating in the torque converter operating mode by determining the status of the lockup clutch 25. The transmission control circuit 40 controls the operation of the lockup clutch 25 via the lockup clutch command output, LCC, as described hereinabove, and the transmission control circuit 40 accordingly has knowledge of the status of the lockup clutch 25. In alternative embodiments, the transmission control circuit 40 may be operable at step 202 to determine whether the torque converter 20 is operating in the torque converter operating mode by monitoring one or more other torque converter operating parameters. For example, the transmission control circuit 40 may be operable at step 202 to monitor the rotational speeds of the pump 18 and of the turbine 22 and determine that the torque converter 20 is operating in the torque converter operating mode if the difference between the two rotational speeds is greater than a predetermined speed value. In any case, the process 200 advances from step 202 to step 204 where the transmission control circuit 40 is operable to determine the rotational speed, PS, of the pump 18 and the rotational speed, TS, of the turbine 22.

Illustratively, the transmission control circuit 40 is operable at step 204 to determine the rotational speed, PS, of the pump 18 by processing the signal produced by the speed sensor 42 to determine the rotational speed of the pump shaft 16. Alternatively, the transmission control circuit 40 may be operable at step 204 to determine the rotational speed, PS, of the pump 18 by receiving or retrieving the engine rotational speed value from the engine control circuit 76 via the one or more signal paths 80. The transmission control circuit 40 may be further operable at step 204 to display the rotational speed of the pump 18, which corresponds to the rotational speed of the output shaft 14 of the engine 12, on the display unit 74 or other conventional display unit controlled by the transmission control circuit 40 to provide the vehicle operator with visual feedback of the current engine rotational speed. Further illustratively, the transmission control circuit 40 is operable at step 204 to determine the rotational speed, TS, of the turbine 22 by processing the signal produced by the speed sensor 46 to determine the rotational speed of the turbine shaft 24.

Following step 204, the process 200 advances to step 206 where the transmission control circuit 40 is operable to determine whether the rotational speed, TS, of the turbine 22 is greater than a turbine speed threshold, TS_{TH}. Illustratively, the turbine speed threshold, TS_{TH}, is selected to be a value above which the rotational speed, TS, of the turbine 22 is sufficiently high to allow an engine output torque value to be computed as a function thereof, as will be described hereinafter, within a desired degree of accuracy. In one embodiment, the turbine speed threshold, TS_{TH}, is a static value stored in the memory 42 of the transmission control circuit 40. Alternatively, the turbine speed threshold, TS_{TH}, may be a dynamic value that changes as a function of the rotational speed, PS, of the pump 18, as a function of the rotational speeds, PS and TS, of the pump 18 and the turbine 22 respectively, and/or as a function of a difference between the rotational speed, PS, of the pump 18 and the rotational speed, TS, of the turbine 22. In any case, if the transmission control circuit 40 determines at step 206 that the rotational speed, TS, of the turbine 22 is not greater than the turbine speed threshold, TS_{TH}, the process 200 loops back to step 202. If, at step 206, the transmission control circuit 40 instead determines that the rotational speed, TS, of the turbine 22 is greater than the turbine speed threshold, TS_{TH}, the process 200 advances to step 208.

At step 208, the transmission control circuit 40 is operable to compute an engine output torque value, EOT, corresponding to an estimate of output torque produced by the engine 12, as a function of the rotational speed, PS, of the pump 18 and of the rotational speed, TS, of the turbine 22. In one illustrative embodiment, the memory 42 has one or more equations stored therein that form a mathematical model of the engine output torque as a function of PS and TS. An example of one such mathematical model of engine output torque is EOT=a*PS²+b*PS*TS+c*TS², where EOT is the compute engine output torque value, PS is the rotational speed of the pump 18, TS is the rotational speed of the turbine 22, and a-c are constants. Other mathematical models that define EOT using one or more other conventional functions of PS and TS or as functions of more, fewer and/or different torque converter 20 and/or transmission 28 operating parameters will occur to those skilled in the art, and any such other mathematical models are contemplated by this disclosure. In other embodiments, the memory 42 may alternatively or additionally have one or more charts, graphs, tables or the like that define EOT values as a function of at least PS and TS.

The process 200 advances from step 208 to step 210 where the transmission control circuit 40 is operable to compute engine horse power, HP, as a function of the engine output torque value, EOT, computed at step 208. Illustratively, the transmission control circuit 40 is operable to compute HP at step 210 using a known relationship between HP, PS and EOT. As one specific example, as described hereinabove with respect to FIG. 2, the transmission control circuit 40 is operable at step 210 to compute the engine horse power, HP, according to the equation HP=(EOT *PS)/5252.

Following step 210, the process 200 advances to step 212 where the transmission control circuit 40 is operable to determine the current engine fueling rate, FR. Illustratively, the engine control circuit 76 is operable to supply fueling rate values to the transmission control circuit 40 via the one or more signal paths 80. The transmission control circuit 40 is thus operable at step 212 to determine the current engine fueling rate, FR, by receiving or retrieving FR from the engine control circuit 76. Thereafter at step 214, the transmission control circuit 40 is operable to compute a fuel efficiency value, FE, as a function of the engine horse power, HP, and the current engine fueling rate, FR. The transmission control circuit 40 may be operable at step 214 to compute the fuel efficiency value, FE, according to any known relationship between FR and HP, and in one embodiment, the transmission control circuit 40 may be operable to compute FE at step 214 according to the equation FE=FR/HP. Alternatively or additionally, the transmission control circuit 40 may be operable at step 214 to compute a fuel consumption rate value, FC, as a conventional function of the current engine fueling rate, FR, over time or per unit of time.

Following step 214, the process 100 advances to step 216 where the transmission control circuit 40 is operable to store in the memory unit 42 any one more of the computed and/or monitored values EOT, HP, FR, FE, FC, PS and/or TS. Alternatively or additionally, the process 200 may advance from step 214 to the process “A” of FIG. 4, as illustrated in FIG. 5. In any case, the process 200 advances from step 216 to step 218 where the transmission control circuit 40 is operable to display on the display unit 74 or other display unit any one or more of the computed and/or monitored values EOT, HP, FR, FE, FC, PS and/or TS. Thereafter at step 220, the process 200 ends.

It will be understood that the process 200 just illustrated and described may be modified such that the transmission control circuit 40 is operable to compute and display and/or store only one or any combination of EOT, HP and FE. Those skilled in the art will recognize that the process 200 may be modified to compute, display and/or store any one or combination of EOT, HP and FE simply by omitting certain steps illustrated in the flow chart depicted in FIG. 5. Any such modifications would be a mechanical step for a person of ordinary skill in the art.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A method for determining performance of an internal combustion engine coupled to a pump of a torque converter, the torque converter having a turbine fluidly coupled to the pump, the method comprising:
locking the turbine in a stationary position,
determining a temperature of a fluid that fluidly couples the pump to the turbine,
determining a rotational speed of the pump in response to a driver requested fueling value with the turbine locked in the stationary position,
mapping the temperature of the fluid and the rotational speed of the pump to an engine output torque value, the engine output torque value corresponding to torque applied by the engine to the pump of the torque converter, and
storing the engine output torque value in a memory unit.

2. The method of claim 1 wherein the memory unit has stored therein a plurality of stall torque maps that each map pump rotational speed values to engine output torque values for a different fluid temperature,
and wherein mapping the temperature of the fluid and the rotational speed of the pump to an engine output torque value comprises:
retrieving from the memory unit a first one of the stall torque maps having a corresponding fluid temperature that is less than the temperature of the fluid,
retrieving from the memory unit a second one of the stall torque maps having a corresponding fluid temperature that is greater than the temperature of the fluid, and
interpolating between the first and the second ones of the stall torque maps to determine the engine output torque value based on the rotational speed of the pump.

3. The method of claim 1 wherein the memory unit has stored therein a plurality of stall torque maps that each map pump rotational speed values to engine output torque values for a different fluid temperature,
and wherein mapping the temperature of the fluid and the rotational speed of the pump to an engine output torque value comprises:
retrieving from the memory unit a one of the stall torque maps having a corresponding fluid temperature that is closest in value to the temperature of the fluid, and
determining from the one of the stall turbine torque maps the engine output torque value based on the rotational speed of the pump.

4. The method of claim 1 wherein locking the turbine in a stationary position comprises engaging a gear of a transmission coupled to the turbine of the torque converter.

5. The method of claim 1 wherein locking the turbine in a stationary position comprises engaging service brakes of a vehicle carrying the engine and the torque converter.

6. The method of claim 1 wherein locking the turbine in a stationary position comprises engaging one or more friction devices within a transmission coupled to the turbine of the torque converter.

7. The method of claim 1 further comprising instructing an operator of a vehicle carrying the engine and the torque converter via a display unit to depress an accelerator pedal of the vehicle in a manner that achieves the driver requested fuel value.

8. The method of claim 1 further comprising displaying the engine output torque value on a display unit.

9. The method of claim 1 further comprising:
receiving another engine torque value from a control circuit configured to control operation of the engine,
determining a difference between the engine torque value the another engine torque value, and
either of storing and displaying the difference between the engine torque value and the another engine torque value.

10. The method of claim 1 further comprising computing an engine horsepower value as a function of the engine output torque value and the rotational speed of the pump.

11. The method of claim 10 further comprising storing the engine horsepower value in the memory unit.

12. The method of claim 11 further comprising displaying the engine horsepower value on a display unit.

13. The method of claim 9 further comprising:
receiving another engine torque value from a control circuit configured to control operation of the engine,
computing another engine horsepower value as a function of the another engine output torque value and the rotational speed of the pump,
determining a difference between the engine horsepower value the another engine horsepower value, and
either of storing and displaying the difference between the engine horsepower value and the another engine horsepower value.

14. The method of claim 10 further comprising determining a fuel rate value corresponding to a fueling rate of the engine when supplying fuel to the engine according to the driver requested fueling value.

15. The method of claim 14 further comprising computing a fuel efficiency value as a function of the engine horsepower value and the fueling rate value.

16. The method of claim 15 further comprising storing the fuel efficiency value in the memory unit.

17. The method of claim 15 further comprising displaying the fuel efficiency value on a display unit.

18. The method of claim 15 further comprising:
receiving another engine torque value from a control circuit configured to control operation of the engine,
computing another engine horsepower value as a function of the another engine output torque value and the rotational speed of the pump,
computing another fuel efficiency value as a function of the another engine horsepower value and the fueling rate value,
determining a difference between the fuel efficiency value and the another fuel efficiency value, and
either of storing and displaying the difference between the fuel efficiency value and the another fuel efficiency value.

19. The method of claim 14 further comprising computing a fuel consumption rate as a function of the fueling rate value.

20. The method of claim 19 further comprising storing the fuel consumption rate in the memory unit.

21. The method of claim 19 further comprising displaying the fuel consumption rate on a display unit.

22. A method for determining performance of an internal combustion engine coupled to a pump of a torque converter, the torque converter having a turbine fluidly coupled to the pump, the method comprising:
locking the turbine in a stationary position,
determining a temperature of a fluid that fluidly couples the pump to the turbine,
determining a rotational speed of the pump in response to a driver requested fueling value with the turbine locked in the stationary position,
mapping the temperature of the fluid and the rotational speed of the pump to an engine output torque value, the engine output torque value corresponding to torque applied by the engine to the pump of the torque converter,
computing an engine horsepower value as a function of the engine output torque value, and
storing the engine horsepower value in a memory unit.

23. The method of claim 22 further comprising displaying the engine horsepower value on a display unit.

24. The method of claim 22 wherein the memory unit has stored therein a plurality of stall torque maps that each map pump rotational speed values to engine output torque values for a different fluid temperature,
and wherein mapping the temperature of the fluid and the rotational speed of the pump to an engine output torque value comprises:
retrieving from the memory unit a first one of the stall torque maps having a corresponding fluid temperature that is less than the temperature of the fluid,
retrieving from the memory unit a second one of the stall torque maps having a corresponding fluid temperature that is greater than the temperature of the fluid, and
interpolating between the first and the second ones of the stall torque maps to determine the engine output torque value based on the rotational speed of the pump.

25. The method of claim 22 wherein the memory unit has stored therein a plurality of stall torque maps that each map pump rotational speed values to engine output torque values for a different fluid temperature,
and wherein mapping the temperature of the fluid and the rotational speed of the pump to an engine output torque value comprises:
retrieving from the memory unit a one of the stall torque maps having a corresponding fluid temperature that is closest in value to the temperature of the fluid, and
determining from the one of the stall turbine torque maps the engine output torque value based on the rotational speed of the pump.

26. The method of claim 22 wherein locking the turbine in a stationary position comprises engaging a numerically low gear of the transmission.

27. The method of claim 26 wherein locking the turbine in a stationary position further comprises engaging service brakes of a vehicle carrying the engine and the torque converter.

28. The method of claim 22 further comprising instructing an operator of a vehicle carrying the engine and the torque converter via a display unit to depress an accelerator pedal of the vehicle in a manner that achieves the driver requested fuel value.

29. A method for determining performance of an internal combustion engine coupled to a pump of a torque converter, the torque converter having a turbine fluidly coupled to the pump, the method comprising:
determining a rotational speed of the pump,
determining a rotational speed of the turbine,
determining an engine output torque value, corresponding to torque applied by the engine to the pump of the torque converter, as a function of the rotational speed of the pump and the rotational speed of the turbine, and
storing the engine output torque value in a memory unit.

30. The method of claim 29 wherein the torque converter has a lockup clutch connected between the pump and the turbine, the torque converter operable in a lockup mode when the lockup clutch is engaged to secure the pump to the turbine and in a torque converter mode when the lockup clutch is disengaged,
and wherein the method is executed only when the lockup clutch is disengaged.

31. The method of claim 29 further comprising displaying the engine output torque value on a display unit.

32. The method of claim 29 further comprising computing an engine horsepower value as a function of the engine output torque value.

33. The method of claim 32 further comprising storing the engine horsepower value in the memory unit.

34. The method of claim 32 further comprising displaying the engine horsepower value on a display unit.

35. The method of claim 29 further comprising determining a fuel rate value corresponding to a fueling rate of the engine when supplying fuel to the engine.

36. The method of claim 35 further comprising:
computing an engine horsepower value as a function of the engine output torque value, and
computing a fuel efficiency value as a function of the engine horsepower value and the fueling rate value.

37. The method of claim 36 further comprising storing the fuel efficiency value in the memory unit.

38. The method of claim 36 further comprising displaying the fuel efficiency value on a display unit.

39. The method of claim 35 further comprising computing a fuel consumption rate as a function of the fueling rate value.

40. The method of claim 39 further comprising storing the fuel consumption rate in the memory unit.

41. The method of claim 39 further comprising displaying the fuel consumption rate on a display unit.

42. A method for determining performance of an internal combustion engine coupled to a pump of a torque converter, the torque converter having a turbine fluidly coupled to the pump, the method comprising:
determining a rotational speed of the pump,
determining a rotational speed of the turbine,
determining an engine output torque value, corresponding to torque applied by the engine to the pump of the torque converter, as a function of the rotational speed of the pump and the rotational speed of the turbine,
computing an engine horsepower value as a function of the engine output torque value, and
storing the engine horsepower value in a memory unit.

43. The method of claim 42 wherein the torque converter has a lockup clutch connected between the pump and the turbine, the torque converter operable in a lockup mode when the lockup clutch is engaged to secure the pump to the turbine and in a torque converter mode when the lockup clutch is disengaged,
and wherein the method is executed only when the lockup clutch is disengaged.

44. The method of claim 42 further comprising displaying the engine horsepower value on a display unit.

45. The method of claim 42 further comprising determining a fuel rate value corresponding to a fueling rate of the engine when supplying fuel to the engine.

46. The method of claim 45 further comprising computing a fuel efficiency value as a function of the engine horsepower value and the fueling rate value.

47. The method of claim 46 further comprising storing the fuel efficiency value in the memory unit.

48. The method of claim 46 further comprising displaying the fuel efficiency value on a display unit.

49. The method of claim 45 further comprising computing a fuel consumption rate as a function of the fueling rate value.

50. The method of claim 49 further comprising storing the fuel consumption rate in the memory unit.

51. The method of claim 49 further comprising displaying the fuel consumption rate on a display unit.
